(19) United States
(12) Patent Application Publication
(10) Pub. No.: US 2012/0063170 A1
(43) Pub. Date: Mar. 15, 2012

(54) MOBILE TERMINAL DEVICE

(75) Inventors: Kouki Murakami, Kawasaki (JP); Takeshi Komuro, Kawasaki (JP); Takashi Suzuki, Kawasaki (JP); Kurumi Harada, Kawasaki (JP); Hiroshi Kubo, Kawasaki (JP)

(73) Assignee: FUJITSU LIMITED, Kawasaki-shi (JP)

(21) Appl. No.: 13/215,835

(22) Filed: Aug. 23, 2011

(30) Foreign Application Priority Data
Sep. 10, 2010 (JP) 2010-203607

(51) Int. Cl. F21V 8/00

(52) U.S. Cl. 362/615

(57) ABSTRACT

A mobile terminal device includes a display module, a holder holding the display module; and a light guide plate disposed on a display side of the display module and held by the holder, the light guide plate including a transparent part and a diffusing part integrated with the transparent part into one structure, the transparent part transmitting light in an area on a display surface of the display module, the diffusing part diffusely reflecting light in an area around the display surface.

### CROSS REFERENCE TO RELATED APPLICATION

This application is based upon and claims the benefit of priority from the prior Japanese Patent Application NO. 2010-203607 filed on Sep. 10, 2010, the entire contents of which are incorporated herein by reference.

### FIELD

The embodiments discussed herein are related to a mobile terminal device.

### BACKGROUND

Some mobile terminal devices such as cell phones include an “illumination”, which is an illumination part emanating light from a certain part of the mobile terminal device. Some mobile terminals are also equipped with a secondary display on the backside of the housing including a primary display. Information such as the current time, an incoming mail alert, and an incoming call alert is displayed on the secondary display.

Referring to FIG. 4, a mobile terminal device according to a conventional art will be described. FIG. 4 illustrates an exemplary mobile terminal device 10 according to a conventional art. The exemplary mobile terminal device according to the conventional art includes a secondary display 11 and an illumination part 12 on the backside of a housing 13 including a primary display. The secondary display 11 displays various kinds of information such as those given above. The illumination part 12 emanates light by receiving light from a light source such as an LED (Light Emitting Diode).

FIG. 5A illustrates a cross-section of the mobile terminal device 10 illustrated in FIG. 4, taken along line X-X. FIG. 5B illustrates a cross-section of the mobile terminal device 10 illustrated in FIG. 4, taken along line Y-Y. As illustrated in FIG. 5A, a housing 13 of the mobile terminal device 10 according to the conventional technique includes a illumination part 12, a secondary display 11, a metal plate 14, a metal member 16 and a buffering member 15, for example. The illumination part 12 acts as an illumination that emanates light by receiving light from a light source, for example. The secondary display 11 displays various kinds of information such as the current time and incoming mail and call alerts.

Components such as the metal plate, the metal member and the buffering member are provided in order to prevent light from leaking from the illumination part to impair the viewability of a display output on the secondary display 12. The metal member 16 is a member that has been used for another purpose, such as a supporting member, and now has a raised height to prevent light emanated from the illumination part 12 from entering the secondary display 11. In the housing 13 of the mobile terminal device 10 according to the conventional technique, the entire illumination part is caused to emanate light by incident light from a light source such as an LED (Japanese Laid-Open Patent Publication No. 2003-177689).

The conventional technique causes light emitted from a single LED to enter the illumination part 12 provided along the direction of the length of the housing 10, thereby illuminating a wide area. However, it is difficult to keep the brightness of regions of the illumination part 12 that are far from the light source uniform with the conventional technique. Consequently, unevenness in light intensity may occur.

There are techniques to improve light intensity today. In one technique, organic electroluminescence (OEL) is used as a light source 17 and the OEL itself is caused to emit light to provide illumination (Japanese Patent Application Publication No. 2006-54624). In another technique, a light guide plate with a dot pattern is used for a liquid-crystal television display to improve light intensity (Japanese Patent Laid-Open Publications No. 2010-21073). In the latter technique, the dot pattern that scatter light is provided to make light intensity uniform. There is another light guide technique that uses a transparent light guide plate that directly transmits light, instead of a light guide with a light-scattering dot pattern.

However, the conventional techniques may not completely block light from entering a display such as the primary or secondary display. For example, the conventional techniques may not completely block light from entering the secondary display because light from the light source in the housing of a mobile terminal device is reflected by edges and other portions of components and the reflected light passes through gaps between the components to reach the secondary display. Consequently, even if a sufficient light intensity may be achieved by any of the conventional techniques, the quality of a display output on the secondary display may be degraded due to the incomplete light blockage.

### SUMMARY

The technique disclosed herein has been devised in light of the problem described above and an object of the technique is to provide a mobile terminal device in which light from a light emitting element provided in the device is effectively prevented from entering a display surface of a display.

According to one aspect of the embodiments, there is provided a mobile terminal device includes a display module, a holder holding the display module, and light guide plate disposed on a display side of the display module and held by the holder. The light guide plate includes a transparent part and a diffusing part integrated with the transparent part into one structure. The transparent part transmits light in an area on a display surface of the display module and the diffusing part diffusely reflects light in an area around the display surface.

The object and advantages of the embodiments will be realized and attained by means of the elements and combinations particularly pointed out in the claims.

It is to be understood that both the foregoing general description and the following detailed description are exemplary and explanatory and are not restrictive of the embodiments, as claimed.

### BRIEF DESCRIPTION OF DRAWINGS

FIG. 1 is an external perspective view illustrating an example of a mobile terminal device according to an embodiment;

FIG. 2 is a cross-sectional view illustrating an exemplary construction inside a first housing of the mobile terminal device, taken along line A-A in FIG. 1;

FIG. 3 is an exploded perspective view of the first housing according to the embodiment;

FIG. 4 is a diagram illustrating an exemplary mobile terminal device according to a conventional technique;

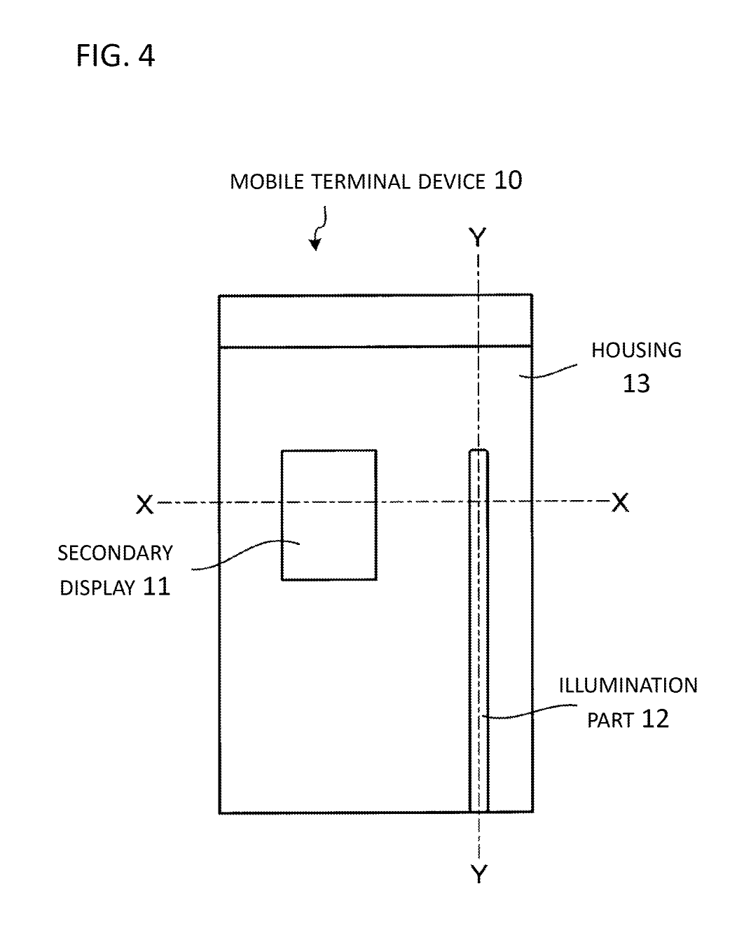

FIG. 5A is a cross-sectional view of the mobile terminal device in FIG. 4, taken along line X-X; and

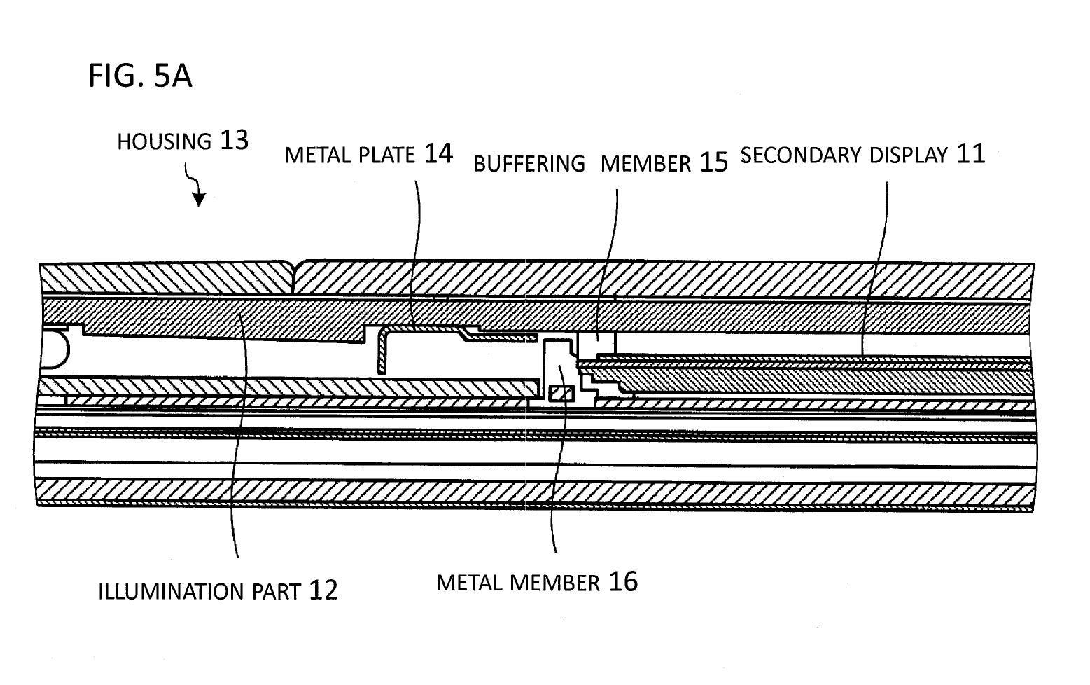

FIG. 5B is a cross-sectional view of the mobile terminal device in FIG. 4, taken along line Y-Y.

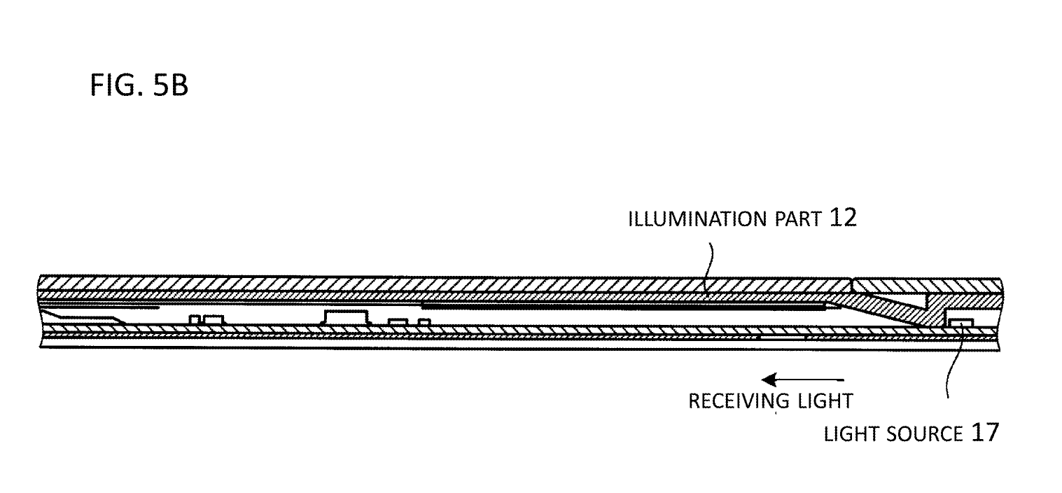

### DESCRIPTION OF EMBODIMENTS

An embodiment of a mobile terminal device disclosed herein will be described below with reference to the accompanying drawings. The embodiment described below are not intended to limit the present invention.

### Embodiment

### External Perspective View

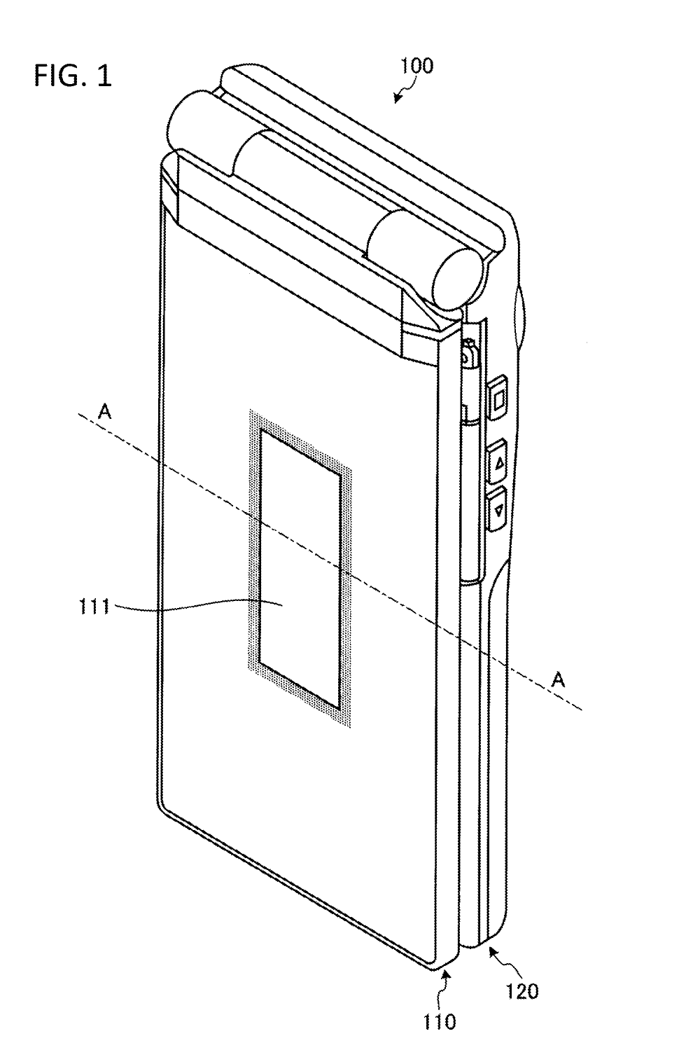

A mobile terminal device according to the present embodiment will be described with reference to FIG. 1. FIG. 1 is an external perspective view of a mobile terminal device according to the present embodiment.

The mobile terminal device 100 includes a first housing 110 and a second housing 120, for example, as illustrated in FIG. 1. The first housing 110 includes a primary display and an ear piece and also includes a secondary display 111 on the backside of the primary display. The secondary display 111 displays various kinds of information such as the current time, an incoming mail alert, and an incoming call alert. The second housing 120 includes operation keys, a mouthpiece, and a battery case. The shaded portion of the secondary display 111 in FIG. 1 represents an example of light emission of an illumination part.

### Construction in Housing

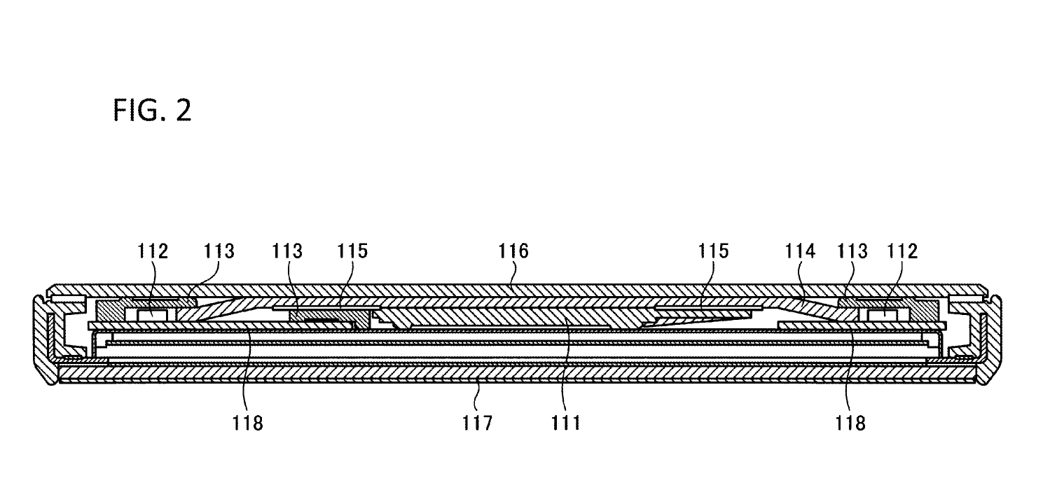

A construction inside the first housing 110 at a cross-section taken along A-A in FIG. 1 will be described with reference to FIG. 2. FIG. 2 is a cross-sectional view illustrating an exemplary construction inside the first housing 110 illustrated in FIG. 1, taken along line A-A.

As illustrated in FIG. 2, the first housing 110 includes the secondary display 111, a light source 112, a holder 113, a light guide plate 114, a reflecting sheet 115, a rear panel 116, a touchscreen 117, and a substrate 118, for example. The secondary display 111 displays various kinds of information such as the current time, an incoming mail alert, and an incoming call alert on the rear panel 116 which is opposite from the touchscreen 117.

The light source 112 may be an LED, for example. Light emitted sideways from the LED enters the light guide plate 114. Any number of light sources 112 may be provided. The holder 113 holds the secondary display 111 and also holds the light guide plate 114. In one mode, the holder 113 may be in any color that reflects little light. An example of color that reflects little light is black.

The light guide plate 114 is disposed on the display output side of the secondary display 111 and is in contact with the display surface of the secondary display 111. The light guide plate 114 includes a transparent part that transmits light in an area on the display surface of the secondary display 111 and a diffusing parts that diffusely reflects light in an area surrounding the display surface. The transparent part and the diffusing part are one integral structure. The light guide plate 114 receives incident light from the light source 112 at its tabs located along the direction of the width of the light guide plate 114 and locked by the holder 113 and also receives incident light from the light source 112 at edges along the direction of the length of the light guide plate 114. The tabs of the light guide plate 114 along the width locked by the holder 13 diffusely reflect light and the edges along the length transmit light in order to maintain a sufficient light intensity.

In order to efficiently diffuse light incident on the edges along the width across the light guide plate 114, preferably the edges along the width are formed into a diffusive shape. The diffusive shape may be a shape in which light from the light source 112, which is a light emitting element, enters the light guide plate 114 at different incident angles in different positions. A shape in which light enters at different incident angles in different positions is a corrugated shape or a jagged shape, for example. On the other hand, the edges along the length are preferably formed into a shape in which light from the light source 112, the light emitting element, enters the light guide plate 114 at the same incident angle in order to make the intensity of light diffusely reflected along the length uniform. A shape in which light enters at the same incident angle is a flat shape, for example.

The diffusing part of the light guide plate 114 acts as an illumination by diffusely reflecting incident light from the light source 112 whereas the transparent part directly outputs a display provided by the secondary display 111. Specifically, light is diffusely reflected in the area of the diffusing part to maintain a uniform light intensity in the area in illumination. On the other hand, light is not reflected but is directly transmitted in the area of the transparent part. Therefore, light is prevented from being reflected in the display area of the secondary display 111 and the viewability of a display is not impaired. Furthermore, light intensity in the direction of the width especially may be further increased because the opposed diffusing parts may receive light directly passing through the transparent part.

Since the holder 113 holds the secondary display 111 and the light guide plate 114 as described above, the holder 113, the secondary display 111 and the light guide plate 114 are integrated into one structure. The integrated structure of these components prevents displacements of a display output on the secondary display 111 and prevents incidence of reflected light on the display surface of the secondary display 111 which would be caused by such displacements. The holder 113 and the light guide plate 114 are thick enough to be in contact with the rear panel 116, which contact prevents deformation of the first housing 110. In addition, since the holder 113 and the light guide plate 114 are in close contact with the first housing 110, light from the light source 112 may be efficiently emanated to the outside of the housing 110.

The reflecting sheet 115 is disposed between and in contact with the holder 113 and the light guide plate 114. The reflecting sheet 115 reflects light traveling from the diffusing part side of the light guide plate 114. The reflecting sheet 115 blocks light traveling from the side opposite from the diffusing part, that is, light traveling from the holder 113. That is, the reflecting sheet 115 reflects light traveling from the diffusing part and blocks light traveling from the holder 113 to further increase the light intensity of an illumination that appears on the rear panel 116.

The rear panel 116 is a panel, for example, that covers the outer surface of the first housing 110 and includes a mirror that allows various kinds of information displayed by the secondary display 111 to be viewed only from outside the first housing 110. Specifically, a mirror structure in an area of the rear panel 116 where a display is provided by the secondary display 111 reflects light traveling from the inside of the first housing 110 toward the outside of the first housing 110. The touchscreen 117 displays various kinds of main information available on the mobile terminal device 100, for example, and may also function as a touch-sensitive input device. The touchscreen 117 does not necessarily function as a touch-sensitive input device; an input device may be provided in the second housing 120 alone. The substrate 118 is a circuit board, for example, on which circuit elements are mounted or printed.

### Exploded Perspective View

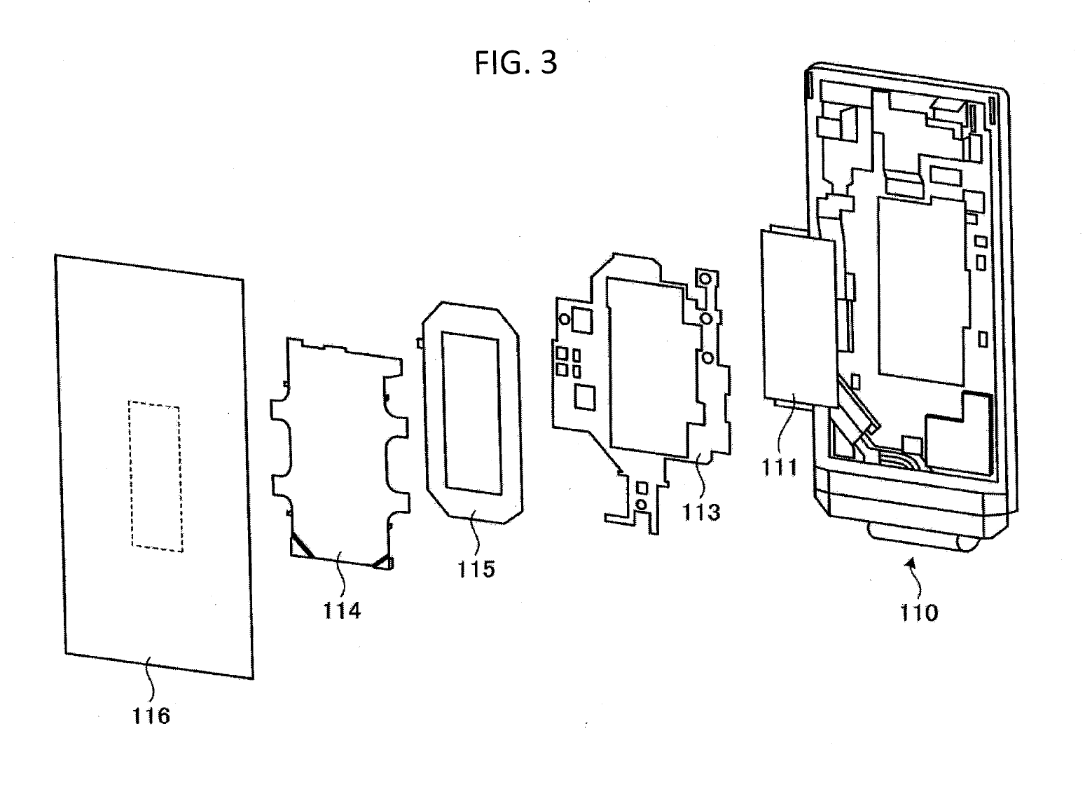

The first housing 110 according to the present embodiment will be described with reference to FIG. 3. FIG. 3 is an exploded perspective view of the housing 110 according to the present embodiment.

As illustrated in FIG. 3, the first housing 110 includes the secondary display 111, the holder 113, the reflecting sheet 115 and the light guide plate 114 in this order from the touchscreen 117 side to the rear panel 116 side, for example. Since the secondary display 111, the holder 113, the reflecting sheet 115, and the light guide plate 114 are integrated into one structure as stated above, displacements of these components do not occur and therefore light that impairs the viewability of a display output on the secondary display 111 does not enter the secondary display 111 through gaps.

### Effects of the Embodiment

As has been described above, the mobile terminal device 100 uses the light guide plate 114 that is a single integral structure including a transparent part that transmits light in an area on the display surface of the secondary display 111 that displays text and images and the diffusing part that diffusely reflects light in an area around the display surface. Furthermore, the secondary display 111 and the light guide plate 114 are held by the holder 113 in the mobile terminal device 100. Accordingly, light from the light emitting element may be more effectively prevented from entering the display surface of the display in the mobile terminal device 100 than in a mobile terminal device that uses any of the conventional techniques in which light inevitably passes through gaps between electronic components to enter the display of the display module even if multiple light blocking components are used.

The mobile terminal device 100 further includes the reflecting sheet 115 disposed between the light guide plate 114 and the holder 113. The reflecting sheet 115 reflects light traveling from the light guide plate 114 and block light traveling from the holder 113. Consequently, in the mobile terminal device 100, the light intensity of an illumination appearing on the rear panel 116 may be further increased. In addition, in the mobile terminal device 100, light from the light source 112, which is a light emitting element disposed near the secondary display 111, may be effectively prevented from entering the display surface of the secondary display 111.

The mobile terminal device 100 further includes the tabs in the light guide plate 114 that are locked by the holder 113. The tabs receive incident light emitted from the light source 112. The tabs along the direction of the width of the light guide plate 114 diffusely reflect light and the edges along the direction of the length transmit light. Consequently, in the mobile terminal device 100, the light raveling through the transparent part to reach the opposed diffusing parts may be further diffusely reflected along the direction of the width, which is a short distance between the opposed parts, and therefore the light intensity of an illumination appearing on the rear panel 116 may be further increased.

While the reflecting sheet 115 that may both reflect and block light is disposed between the holder 113 and the light guide plate 114, the reflecting sheet 115 may be omitted. Even if the reflecting sheet 115 is omitted, the light guide plate 114 which includes the diffusing part and the transparent part integrated with each other may prevent light from the light source 112 disposed near the secondary display 111 from entering the display surface of the secondary display 111. The locations of components such as the tabs in the embodiment described above are not limited to those illustrated; the components may be disposed in any places in the housing 110.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a depicting of the superiority and inferiority of the invention. Although the embodiments of the present invention have been described in detail, it should be understood that the various changes, substitutions, and alterations could be made hereto without departing from the spirit and scope of the invention.

What is claimed is:

1. A mobile terminal device comprising:
a display module;
a holder configure to hold the display module; and
a light guide plate disposed on a display side of the display module and held by the holder, the light guide plate including a transparent part and a diffusing part integrated with the transparent part into one structure, the transparent part transmitting light in an area on a display surface of the display module, the diffusing part diffusely reflecting light in an area around the display surface.

2. The mobile terminal device according to claim 1, further comprising a reflecting/blocking member disposed between the holder and the light guide plate, the reflecting/blocking member reflecting light travelling from the diffusing part of the light guide plate and blocking light traveling from the holder.

3. The mobile terminal device according to claim 1, wherein the light guide plate further comprises a holding tab locked by the holder and receives light incident on the tab from a light source.

4. The mobile terminal device according to claim 2, wherein the light guide plate further comprises a holding tab locked by the holder and receives light incident on the tab from a light source.

5. The mobile terminal device according to claim 3, wherein a side of a first edge of the light guide plate diffusely reflects light at the holding tab located along a direction of the width of the light guide plate and transmits light at a second edge of the light guide plate, the second edge being located along a direction of the length of the light guide plate.

6. The mobile terminal device according to claim 5, wherein the side of the first edge of the light guide plate at the holding tab is undulated so as to reflect light by the side of a first edge of the light guide plate.

7. The mobile terminal device according to claim 5, wherein the light source adjoins the side of the first edge of the light guide plate at the holding tab.
